(19) United States
(12) Patent Application Publication
(10) Pub. No.: US 2005/0198318 A1
(43) Pub. Date: Sep. 8, 2005

(54) Wireless/wired token access distributed network and system for using same

(76) Inventors: Clay von Mueller, San Diego, CA (US); Kyle R. Zaidain, Half Moon Bay, CA (US); Jonathan E. Sarkisian, San Diego, CA (US); Konrad J. B. Andersen, El Cajon, CA (US); Robert J. Mos, San Diego, CA (US); Kim P. S. Zaidain, Half Moon Bay, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 10/840,121

(22) Filed: May 6, 2004

Related U.S. Application Data
(60) Provisional application No. 60/468,443, filed on May 6, 2003.

(51) Int. Cl. G06F 15/16

(52) U.S. Cl. 709/228

(57) ABSTRACT

The present invention is directed to a combination wireless and wired token access distributed network and system comprising a secure locator network (SLN) system having one or more network system controllers (NSCs), and where the data collection and transmission nodes (DCTNs) are magnetic stripe card readers or chip card readers that broadcast the data read from the data token card to data access points (DAPs) using wireless communications. The DAPs store the data in a table which is made available for TCP/IP access. The NSCs contain processing software which poll the DAPs at regular intervals, captures the resulting data table, parses said data and stores it in a database. This data is available for applications residing on the NSCs. If the SLN is connected to a larger network, such as a global computer network, applications on other linked computers or data processors can access the data for processing, depending upon security considerations and protocols. The system can be readily used in restaurant service applications, gaming tracking applications and entry access applications, to provide enhanced security and increased efficiency in service.

This application claims the benefit of U.S. Provisional Patent Application Ser. No. 60/468,443 filed on May 6, 2003.

### FIELD OF THE INVENTION

The present invention relates to a new and improved token access distributed network and a system for using it, more specifically, the present invention relates to a token access and verification system using a distributed network with wired and wireless components to remotely locate and verify tokens used for various data collection, entry and authentication purposes.

### BACKGROUND OF THE INVENTION

There are many instances when a method of tracking the location of an object or individual in a low cost and unobtrusive way is of benefit.

One such use is in tracking customer location in restaurants. The customer places an order and receives a token prior to being seated. When seated a token reader located at the customer table is activated and sends the order number and table location to a display device serving the food delivery waiters. When the waiter delivers the food the token is again activated to close the ticket. In addition to directing the waiter to the correct table for food delivery the system also tracks the time to deliver each customer's food and informs the delivery supervisor if a customers order is not delivered within a specified time frame. An extension to this system is adding a display with touch screen to the token reader located at the customer table. In this case the customer may go directly to a table upon entry to the restaurant, place an order, and make payment from the table using a credit card or a cash value card. The customer's signature is captured with the touch screen for card verification. In addition the food delivery person can use the token reader to track the time from order to delivery. In situations where the added cost or other concerns do not permit each table token reader to contain a display or input device a portable version of the token reader with a display, input device, and optionally a reader is supplied to the waiter to complete the order and payment transaction with the customer.

The restaurant can also use the token as a customer loyalty device by tracking and rewarding the token's usage. In this case the token is also an advertising tool for the restaurant. A restaurant chain could grant access to loyalty rewards over all of its stores. A restaurant, restaurant chain, or coalition of restaurants could also implement a cash value loyalty token. This type of cash value card would also be of benefit at colleges and other large organizations for the cashless purchase of small items from such venues as vending machines, laundries, and cafeterias.

Another use is at conventions where each attendee is given a token for expediting requests for information from the convention participants. In the current system the attendee can use the token at any booth he/she attends and the data gathered is limited. In the described system the use of each token is tracked and logged dynamically with location and time to a central database. The gathered information can be used to alter the grouping and location of participant's booths to better serve the attendees.

Gaming casinos are another venue where this system serves to improve operational efficiency. Casinos are interested in tracking the operation of electronic gaming machines (e.g., slot machines and card game machines) as well as activity at gaming tables. They are interested in encouraging increased activity with promotional gifts and rewards for their better customers. Just as tokens given to customers can be used for player tracking functions, token readers are used to monitor and report on the operation and status of the games.

Many of the gaming machines are hardwired to high-speed networks to provide player tracking and machine operational status functions. If it is advantageous to relocate gaming machines, significant effort must be expended to detach and move the hard-wired network components. With the wireless version of this system machines can simply be moved within the broadcast range of the network (which can be expanded incrementally) without touching the network components. Additional technologies combined with the token and wireless components can assure the security of the tokens and system decrement and cash value operations can be supported. With a display and input device such as a touch screen or keypad added to the token reader multiple unique features can be added to the basic system. The token reader can be used as a small gaming device at locations such as restaurant tables where traditional gaming machine would not fit or be appropriate.

In all of these applications the token can have many forms depending on the required usage and cost. Non-contact chip or smart cards can be used when real time tracking of movement is desired. Contact chip cards are preferred when large amounts of customer data must be transferred to the system at each token reader. Magnetic stripe cards are preferred when low cost and/or customer retention of the token is desired. A magnetic stripe card enhanced with patented SecureStripe™ technology is the preferred medium for cash value systems.

In the above examples a wireless token reader is generally preferable to a wired version due to the ease of installation and the subsequent ease in which the tables and booths can be moved to facilitate cleaning and redistribution of resources. The wireless component of the system can also be used for other services. A waiter may wish to add items to a customer's order while at the table or process a credit card transaction with a wireless handheld device. Any of the configurations can incorporate hard-wired connection when specific security or environmental issues must be addressed.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The principle object of this invention is to create a combination wireless and wired secure token access distributed network and system for using same comprised of data collection and transmission nodes (DCTNs), data access points (DAPs), repeater access points (RAPs), and network system controller (NSC) components.

Another object of this invention is to create a combination wireless and wired token access distributed network and system where the DCTNs are magnetic stripe card readers that broadcast the data read from the card to the DAP using wireless communications.

Another object of this invention is to create a combination wireless and wired secure token access distributed network and system where the DAP stores the data in a table which is available for TCP/IP access.

Another object of this invention is to create a combination wireless and wired secure token access distributed network and system where the NSC contains processing software which polls the DAP at regular intervals, captures the data table, parses the data and stores it in a database, making this data available for applications residing on the NSC.

Another object of this invention is to create a combination wireless and wired secure token access distributed network and system where if the SLN is connected to a larger network, applications on other machines can access the data for processing as well depending on security considerations.

Another object of this invention is to create a combination wireless and wired secure token access distributed network and system where multiple DAPs are used to increase the coverage area and the number of DCTNs available for data acquisition.

Another object of this invention is to create a combination wireless and wired secure token access distributed network and system where the broadcast ranges of the DAPs overlap to provide some redundancy in the system and to aid diagnostics in pinpointing the location of failures or environmental interference.

Another object of this invention is to create a combination wireless and wired secure token access distributed network and system where each DAP is cabled to the NSC and may communicate with any DCTN in its broadcast radius.

Another object of this invention is to create a combination wireless and wired secure token access distributed network and system where RAPs are used to extend the range of the SLN.

Another object of this invention is to create a combination wireless and wired secure token access distributed network and system where each RAP may communicate with any DCTN in its broadcast radius.

A further object of this invention is to create a combination wireless and wired secure token access distributed network and system where other methods can be used to extend the range of an SLN, such as nesting multiple SLNs in a larger network.

Yet another object of this invention is to create a combination wireless and wired secure token access distributed network and system where multiple SLNs are nested in the same network.

A final object of this invention is to create a combination wireless and wired secure token access distributed network and system which employs an overall controlling NSC to coordinate SLN activities when additional computing power is required since it is usually more expensive than using RAPs to extend a network's range.

The preferred embodiment of the invention comprises a basic secure locator network (SLN) where the DCTNs are magnetic stripe card readers that broadcast the data read from the card to the DAP using wireless communications. The DAP stores the data in a table which is available for TCP/IP access. The NSC contains processing software which poles the DAP at regular intervals, captures the data table, parses the data and stores it in a database. This data is available for applications residing on the NSC. If the SLN is connected to a larger network, applications on other machines can access the data for processing as well depending on security considerations.

A first alternate embodiment of the invention comprises a secure locator network with built-in redundancy features in which multiple DAPs are used to increase the coverage area and the number of DCTNs available for data acquisition. The broadcast ranges of the DAPs overlap to provide some redundancy in the system and to aid diagnostics in pinpointing the location of failures or environmental interference. Although it is not shown in the figures presented below, each DAP is cabled to the NSC and may communicate with any DCTN in its broadcast radius.

A second alternate embodiment of the invention comprises a RAP extended range secure locator network (SLN) in which RAPs are used to extend the range of the SLN. Here, each RAP may communicate with any DCTN in its broadcast radius.

A third alternate embodiment of the invention comprises a nested secure locator network in which multiple SLNs are nested in the same network. This method usually employs an overall controlling NSC to coordinate SLN activities. Generally, it is only used when additional computing power is required since it is usually more expensive than using RAPs to extend a network's range. Each DAP may communicate with any DCTN in its broadcast radius.

It must be clearly understood at this time although the preferred embodiment of the invention consists of the combination wireless and wired token access distributed network and system means, that many conventional hard wired and wireless token access and networking devices exist, including those employing DCTNs, DAPs, NSCs and wired as well as wireless communication means, or combinations thereof, that will achieve a similar operation, and they will also be fully covered within the scope of this patent.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a basic combination wireless and wired secure token access distributed network and system locator network;

FIG. 2 depicts a combination wireless and wired secure token access distributed network and system locator network with built-in redundancy;

FIG. 3 depicts a combination wireless and wired secure token access distributed network and system RAP extended range locator network; and

FIG. 4 depicts a combination wireless and wired secure token access distributed network and system nested locator network;

For a fuller understanding of the nature and objects of the invention, reference should be had to the following detailed description taken in conjunction with the accompanying drawings which are incorporated in and form a part of this specification, illustrate embodiments of the invention and together with the description, serve to explain the principles of this invention.

### DETAILED DESCRIPTION OF THE PREFERRED EMBODIMENTS

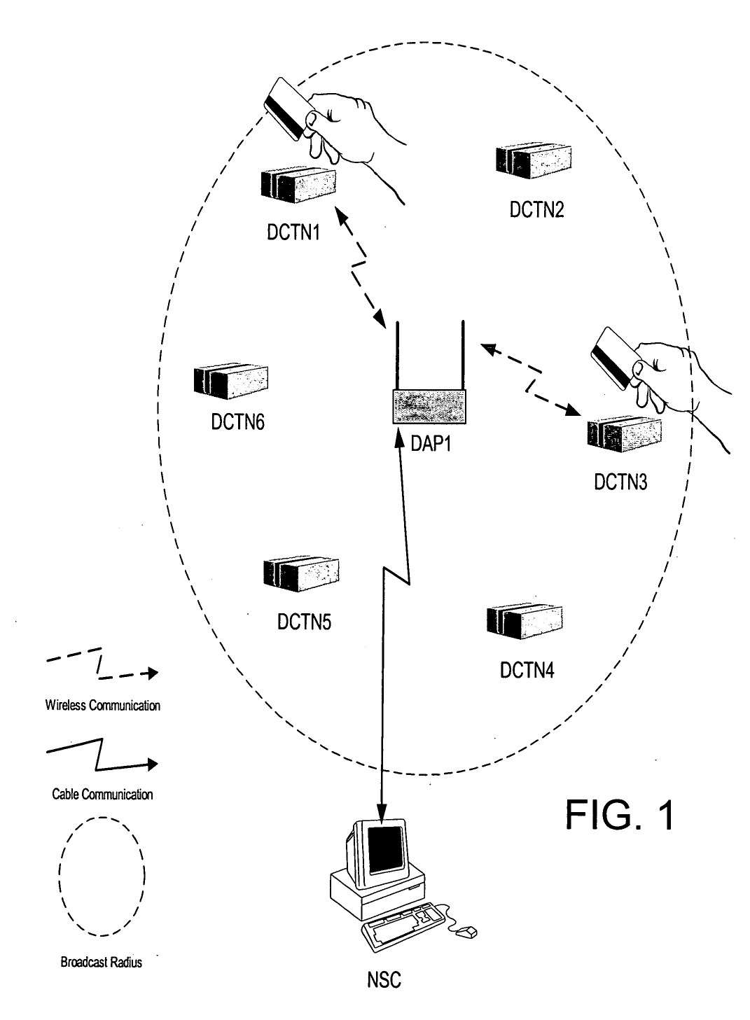

Referring now to FIG. 1 there is shown a basic secure locator network (SLN). In FIG. 1, the DCTNs are magnetic stripe card readers that broadcast the data read from the card to the DAP using wireless communications. The DAP stores the data in a table which is available for TCP/IP access. The NSC contains processing software which poles the DAP at regular intervals, captures the data table, parses the data and stores it in a database. This data is available for applications residing on the NSC. If the SLN is connected to a larger network, applications on other machines can access the data for processing as well depending on security considerations.

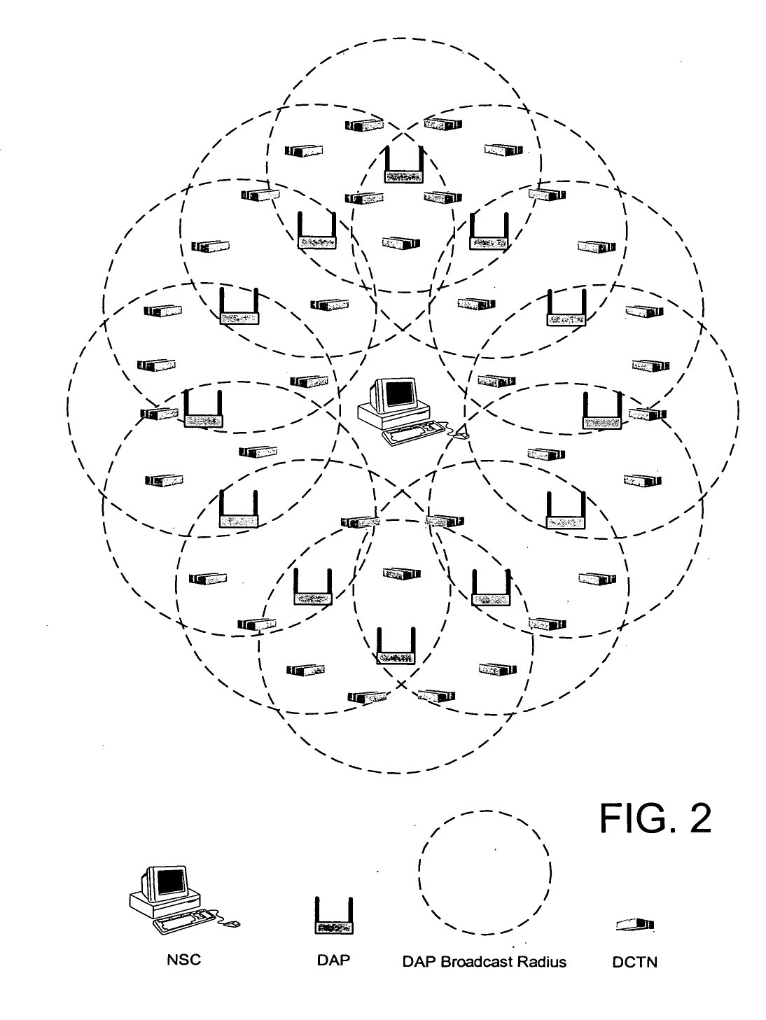

Referring now to FIG. 2 there is shown a secure locator network with built-in redundancy features. In FIG. 2, multiple DAPs are used to increase the coverage area and the number of DCTNs available for data acquisition. The broadcast ranges of the DAPs overlap to provide some redundancy in the system and to aid diagnostics in pinpointing the location of failures or environmental interference. Although it is not shown in the diagram (to reduce clutter), each DAP is cabled to the NSC and may communicate with any DCTN in its broadcast radius.

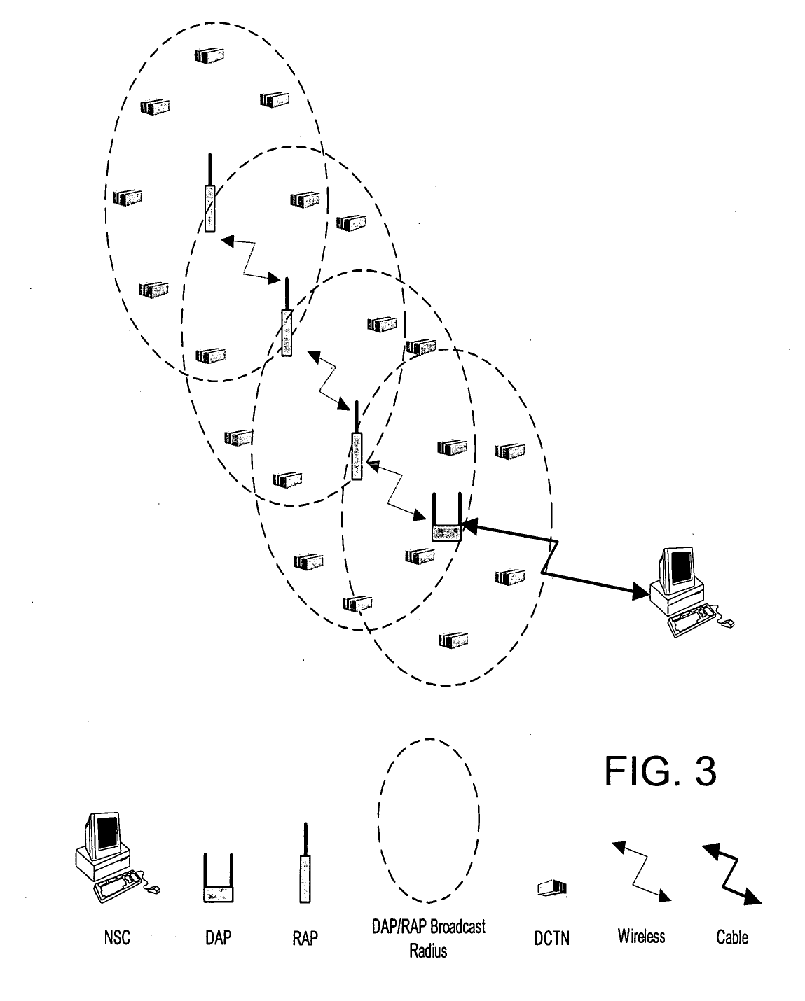

Referring now to FIG. 3 there is shown a RAP extended range secure locator network (SLN). In FIG. 3, RAPs are used to extend the range of the SLN. Although it is not shown in the diagram (to reduce clutter), each RAP may communicate with any DCTN in its broadcast radius.

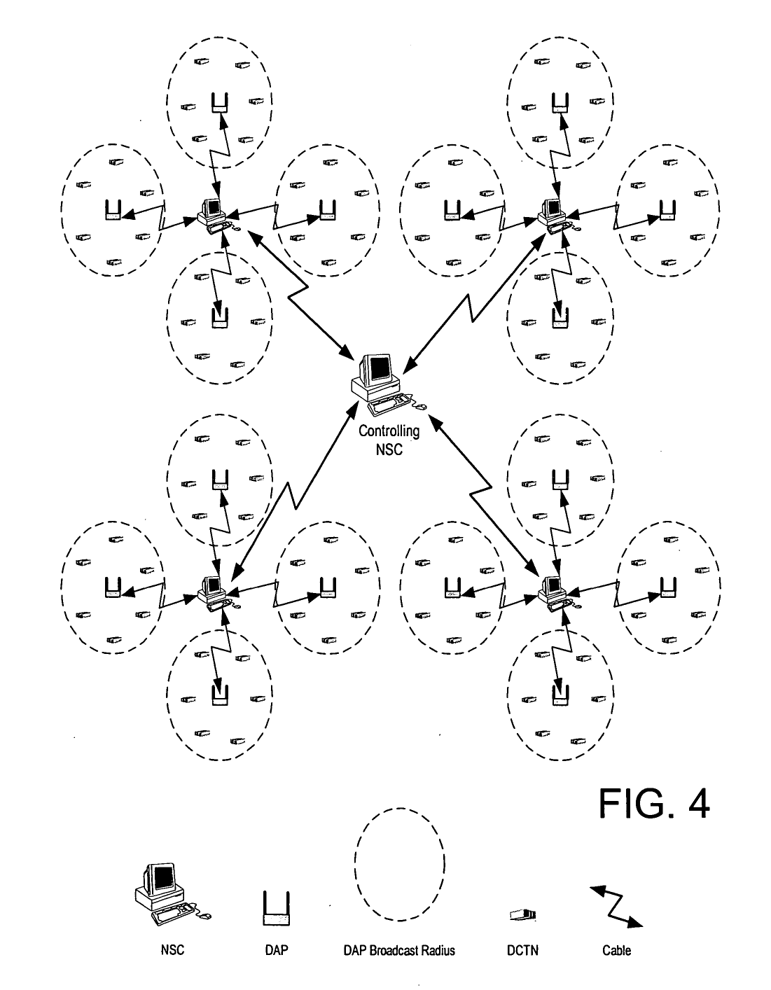

Other methods can be used to extend the range of an SLN, such as nesting multiple SLNs in a larger network as shown in FIG. 4, below.

Referring now to FIG. 4 there is shown a nested secure locator network. In FIG. 4, multiple SLNs are nested in the same network. This method usually employs an overall controlling NSC to coordinate SLN activities. Generally, it is only used when additional computing power is required since it is usually more expensive than using RAPs to extend a network's range. Although it is not shown in the diagram (to reduce clutter), each DAP may communicate with any DCTN within its broadcast radius.

There is seen in FIG. 1 a secure locator network (SLN) system which is a multi-use network combining wireless and hard connectivity, ID tokens, data collection devices of various types, and processing software, both firmware and application.

Components

An SLN makes use of four (4) main classes of components. They are:

1. Data Collection and Transmission Node (DCTN). A DCTN can be one of several types of devices that are capable of collecting and transmitting data. Examples include magnetic stripe token readers, smart chip readers, sensor probes, and personal digital assistants (PDAs), as well as custom-built devices with embedded controllers. In most cases the component has or is combined with a wireless data transmitter or transceiver, depending on the application. However, when wireless communication may encounter data loss or present security concerns, the DCTN can be cabled directly into the network. The DCTN firmware can collect and transmit data using standard or custom encryption techniques depending on application requirements.

While it is desired for the wireless transmission protocol to support bi-directional data transmission to insure data integrity in some application s the increase in system cost cannot be justified. In these cases, a DCTN incorporates only a wireless transmitter and single direction transmission. In this case when data is collected by the DCTN it is transmitted a multiplicity of times at random intervals. The number of transmissions and the data packet length are adjusted to appropriate values for the desired use.

While it is usually desirable for the wireless transmission medium to be RF it is understood that other mediums such as infer-red would also support this system operation.

2. Data Access Point (DAP). A DAP collects data from the DCTNs in its control area, either through wireless communication or direct cabling. The DAP firmware makes this data available, either in raw or formatted form, to the network system controller (NSC). Data formats may conform to industry standards or be customized according to application requirements. The DAP firmware can collect and transmit data using standard or custom encryption techniques depending on application requirements. A DAP may communicate (usually via TCP/IP) to an NSC wirelessly, by direct cable, Repeater Access Point (RAP), or via the Internet if a connection is available and the security restrictions do not prohibit it.

An SLN usually contains more than one DAP, each with DCTNs with its broadcast range. DAP broadcast ranges can overlap, either by design or due to the signal strength variations associated with wireless communication. If security or organizational needs require that the set of DCTNs reporting to a given DAP be fixed, the system can accommodate it. However, the basic system is designed so that a DCTN can transmit to any DAP with which it establishes a good connection.

There are several reasons for this:
It ensures that the shortest data cycle interval can be maintained by the system.
It prevents data loss because this redundancy allows a DCTN to transmit successfully even if its nearest access point goes down.
It allows for the easy relief of a data bottleneck when the amount of data per transmission, frequency of transmission events per DCTN, or number of actively transmitting DCTNs threatens to overwhelm the ability of the DAPs to collect and process data within the optimum data cycle interval. The remedy can be as simple as putting another DAP within range of an appropriate number of DCTNs. In most cases, the only additional requirement is the addition of the DAPs ID code to the NCSs Active DAP Query table. This can be anticipated and allowed for during the initial system setup or set during operation dynamically.
It provides diagnostic data for the system. Each DCTN and each DAP has a unique identifier that can be incorporated into each data record stored on the NSC. Applications can make use of this information to statistically analyze changes in performance over time. If certain DCTNs, consistently reporting to a particular DAP, begin transmitting to a different DAP, it may indicate a problem with the first DAP or point to new environmental factors interfering with communications. Again, it provides redundancy to mitigate any impact on system performance.
It acts as a bridge between the local DCTN network and other networks. In one case a DAP connected to the Internet and the local DTCN network supporting TCP/IP connections the DAP can be any device with TCP/IP connectivity and a DCTN compatible wireless link. In this case a PDA with a TCDN module can access and be accessed via a remote Internet connection.

3. Repeater Access Point (RAP). A RAP collects data from the DCTNs in its control area, either through wireless communication or direct cabling. RAP firmware makes this data available; either in raw or formatted form, to requesting DAP(s), other RAPs or an NSC. The primary function of a RAP is to extend the access range of wireless versions of the SLN.

4. Network System Controller (NSC). The NSC is a computer and typically, though not necessarily, has a fixed disk, a display, and an input device.

It is connected to the SLN by direct cable, wireless transceiver, or via the internet (or some combination of these), and retrieves data from the DAP(s) listed in its Active DAP Query table. It contains one or more software applications to facilitate this. Individual applications parse the data and store it in one or more databases. It is possible to have multiple software applications which parse, store and process the same data in different ways. Applications may also selectively treat the data from different DCTNs or DCTN types in different ways (see the examples described later in this document).

In some configurations, the NSC runs a Web server such as Microsoft IIS™ with custom active server pages (ASP) for display and manipulation of the data. This also provides remote access if the NCS is connected to the World Wide Web and security restrictions allow it.

It is possible for an SLN to contain more than one NSC, either to provide additional data processing capabilities or to multiply the size of the network by nesting smaller SLNs within it. In the latter case, one NSC may collate data and control the activities of other NSCs if the application requires it.

Base Configuration

The base configuration consists of one or more wireless DCTNs strategically located within a target area. Also within the target area are one or more wireless DAPs each with a unique network IP address, connected to an NSC by a network cable or a wireless HUB Each DAP receives the data transmitted from the DCTNs within their effective broadcast range. The DCTN(s) may be any of several types of devices, which can be mixed and matched depending on the application need.

A DCTN transmits a data burst, which is triggered whenever one or more of the data values it collects changes. The DCTN establishes a connection with a DAP, establishes a successfull handshake, including ID/security procedures as needed, and transmits the data. The DAP creates a new record each time it receives a data burst from a DCTN and stores that record in a table.

The NSC polls the DAP(s) at regular intervals, captures the data table, parses it and stores the data in one or more database tables, either by inserting new records or updating old ones. In some cases, values in the new records may trigger other actions controlled in software (e.g., record deletions).

Various applications on the NSC now process the data and use it for various tasks such as information display, statistical analysis, remote monitoring and the trigger of alarms, and the generation of various reports.

### SYSTEM CONFIGURATION EXAMPLES

Installed Configuration 1—The Table Locator Network (TLN)

The TLN is the primary operational configuration. It can be readily installed for operation in any restaurant.

The TLN DCTN is a magnetic stripe card reader with a wireless transmitter. One DCTN resides at each table in the restaurant and has the table ID encoded in its firmware. A specially encoded DCTN is installed at the waiter station. The TLN DAP contains a wireless transceiver, a NIC with a Cat5 connector, and a mini-webserver. It is connected by cable to the NSC. The TLN NSC consists of a Pioneer POS touchscreen computer running the Microsoft Windows 2000™ operating system and the TLN application software.

The TLN was designed to facilitate order delivery in the restaurant. This restaurant took customer orders at the cash register. The customer was given a card with a number printed on it. The customers then found tables in the large dining area and placed the card on the table for the delivery person to find. With a crowded restaurant the card frequently was hidden from the delivery persons sight.

The new TLN procedure followed these steps:

1. The customer places an order and pays at the cash register

2. The cashier has a supply of magnetic stripe cards, each with a unique number printed on the card and encoded in its magnetic stripe. The cashier records the number of a card directly into the register so that the card number is associated with the order that is passed to the kitchen. The cashier then gives the card to the customer.

3. The customer finds a table and swipes the card through a card reader (DCTN) on the table. A flashing green LED signal tells the customer that the card was read successfully. A flashing Red LED signals the customer to swipe the card again. After a good swipe the green LED flashes periodically for 10 minutes to notify waiters that a successful card swipe was made.

4. The unique card number and unique table number are transmitted wirelessly to a DAP located in the restaurant. Any number of card/order numbers can be associated with a single table (DCTN) as long as each card holder swipes his card.

5. The DAP inserts a record into a data array in its firmware. The record consists of the record number, the card number, the table ID, and a time stamp based on the clock in the DAP. The array is then wrapped in html and made available on the mini-web server for response to a standard http request to its network IP address.

It is also possible to make the data available as a single string. However, when an internet connection is provided, the html version of the data is available for remote monitoring and retrieval.

6. At regular intervals (adjustable through the software, with a default of 10 seconds) the TLN application in the NSC queries the DAP via its network IP address using a standard http request. It downloads the current html page and parses it, extracting the individual records from the data array.

It determines if a record is new for the card-table combination, or if it is a deletion record (See Step 9, below).

7. New card-table combinations are inserted into the TLN database and time stamped based on the clock in the NSC. If a previous active record exists for the card at a different table, the old record is updated with the new location. In this way, an order will follow a customer who moves to a different table.

8. The currently active order records are displayed on the NSC screen with icons for each active, unfilled order, displaying the order/card number, table ID, and wait time. The records can be sorted by location/table, order or wait time.

The wait time is calculated as the difference between the time the order was placed (time stamped by the NSC) and the current NSC time. This is recalculated for each active record at regular intervals (adjustable through the software, with a default of 10 seconds). If a record ages beyond a preset value (also adjustable through the software) the order icon changes color. It can also be made to flash and/or give an audible warning.

The display tells the waiters where each order should be delivered and how long the customer has waited for it.

9. When a waiter delivers an order, he collects the card from the customer and carries it back to the waiter station where he swipes it through the specially encoded DCTN. This causes a new record to be transmitted to the DAP with a deletion code for the card/order number. When the TLN software does its next data retrieval, the active record for that card/order is time stamped and marked inactive. Records are not deleted permanently from the database except through the database maintenance routines. Records are made inactive, so that the data remains for analysis (e.g., determining peak activity hours, or mean delivery time).

Future versions may include a different or additional mechanism for closing an order. The waiter may carry a specially encoded card that can be swiped through the DCTN at the table to either close out all orders at that table or close any record associated with the next card swiped through that DCTN.

Installed Configuration 2—iTracker

The first version of the iTracker gaming system can be readily installed in any gaming environment such as a casino.

The iTracker DCTN is a device with a wireless transceiver and an embedded controller which tracks the status counters in slot machines. One DCTN resides in each electronic slot machine in the casino and has a DCTN ID encoded in its firmware. The iTracker DAP contains a wireless transceiver, a NIC with a Cat5 connector, and a mini-webserver. It is connected by cable to the NSC. The iTracker NSC consists of a Pioneer POS touch screen computer running the Microsoft Windows 2000™ operating system and the iTracker application software. It also has Microsoft IIS™ running and employs active server pages (ASP) to provide remote data viewing capabilities. Future versions will use ASP as the primary user interface on the NSC.

iTracker was designed to facilitate accurate real-time accounting and activity information regarding installed electronic slot machines to both casino personnel and the owners of the machines who are generally different entities. It also provides compliance for new government revenue reporting requirements for Indian gaming.

The iTracker system data flow follows these steps:

1. Each time data changes in one or more of the thirteen numeric buckets in an electronic slot machine, the DCTN records the current contents of all buckets in the machine and transmits the data wirelessly to a DAP located in the casino. Some of the buckets contain static data such as a unique location (machine) identifier. Others contain counters for recording the number of coins in and out, jackpots paid, and so on. One bucket is a one minute elapsed time counter which guarantees each game will attempt to transmit is status every minute. Some examples of changes that will trigger data transmission are an increment in the coin count due to a customer dropping a coin in the slot, or a decrement as the result of a payoff.

2. The DAP inserts a record into a data array in its firmware. The record consists of a comma delimited string which includes a record number provided by the DAP and values for each of the thirteen buckets. The array is then wrapped in html and made available on the mini-web server for response to a standard http request to its network IP address.

It is also possible to make the data available as a single string. However, when an internet connection is provided, the html version of the data is available for remote monitoring and retrieval.

3. At regular intervals (adjustable through the software) the iTracker application in the NSC queries the DAP via its network IP address using a standard http request. It downloads the current html page and parses it, extracting the individual records from the data array.

It determines if a record is new for a specific location (machine) or is an update for an existing record. In both cases, a time stamp based on the NSCs clock is added to the data. New records are inserted; updates simply replace existing data with newer data. Records are never deleted except through the database maintenance routines.

4. At regular intervals (adjustable through the software) the iTracker application copies all existing records in the Current table to a History table in the database. This table provides data for historical analysis (e.g., determining peak activity hours, or machines or locations with the most activity, and so on).

5. The currently active location records are displayed on the NSC screen with icons for each active, location, displaying the location/machine number, coins in, coins out, and the drop (difference). The records can be sorted by any of the database fields, with location being the default.

Proposed Configuration 1—TLN Version X

Some proposed changes for the Table Locator Network (TLN) are:
The addition of PDAs as DCTNs. Waiters would carry them and make additions to orders or take orders and credit card payment at the table. The card readers employed would be SecureStripe™ compliant to ensure authenticity of the card.
Application software would make it possible for the waiter to enter an order on the PDA, possibly downloading current menu options and prices on the spot. Other information may be made available as well, such as anticipated wait time for the order and availability of menu items.
If the NSC has a connection to the internet other services may be offered such as the availability and purchase of show tickets as an added convenience for the patrons and additional revenue for the restaurant.
   Proposed Configuration 2—iTracker Version 2

This alternate version of the iTracker gaming system can be readily installed and operated in any gaming environment. Additionally, it is easily scalable to any size gaming facility, including those running thousands of gaming machines, such as conventional slot machines, video slot machines, video poker machines, etc.

The changes for iTracker V2 consist of the following:
System capabilities must support several thousand machines. This will necessitate the use of multiple DAPs and possibly, multiple NSCs. In the former case, a polling routine in the NSC will cycle through all DAPs in its Active DAP Query table. In the latter case, a data synchronization routine may be utilized or a “super” NSC employed to coordinate the data acquisition and storage activities of the other NSCs.
Management and analysis reports based on both the current and historical data will be generated.
   Proposed Configuration 3—iTracker Version X

Future changes for iTracker may include the following:
The ability to send commands to the DCTN(s) in a specific machine or a group of machines (e.g., a command which causes the machine to shut down).
   Proposed Configuration 4—Player Tracker

A player tracking system is being designed that will employ the features of the basic SLN with a number of enhancements. When a player enters a casino he/she will be signed in as a guest and issued a magnetic SecureStripe™ Card. This card will be used as a device to track the activity of a player in the casino and to offer “bonuses” during his/her stay.

The card can act as a “decrement” card if the player places a certain dollar amount on the card through the cashier (usually at sign up time). The DCTN at each table contains a SecureStripe™ reader/writer. When a player arrives at a gaming table he, or the dealer/croupier, swipes his card which starts or updates an activity log for the player in the system.

In some configurations, the DCTN may be a PDA or its fixed equivalent. This allows the dealer to sell chips to a player and decrement his guest card, or even charge it to a credit card. It also gives the system an enhanced ability to issue bonuses or incentives either automatically (based on the quantity of chips purchased, for example) or through intervention by management. This may take the form of additional chips, or a message to the dealer or pit boss that a special consideration, such as a dinner or a show, has been offered.

Proposed Configuration 5—STADDS Compatibility

Any SLN can be enabled for access to a Secure Token Access Distributed Database System (STADDS). This opens up a number of possibilities for enhanced security and data collection. The Player Tracking system mentioned above, could make use of STADDS to establish Identity, assess risk, and even gain insight to individual player preferences and patterns.

Proposed Configuration 6—Sensor Arrays

Any situation that requires environmental monitoring can make use of an SLN. Probes with low energy requirement can be incorporated into the DCTN of a system. A greenhouse that must monitor humidity, temperature, and soil ph is one example; a data center is another. Heat sensors and motion sensors can be employed, for example, to protect against fire or intrusion.

This data can be collected and polled every few seconds as described in the previous configurations. Application software in the NSC can monitor the data value fluctuations and trigger alarms when certain range limits are exceeded in either direction. With the use of an internet connection and active server pages as described in the iTracker installation, data can be monitored and alarms triggered anywhere in the world. Warnings and requests can be relayed to appropriate response personnel anywhere at any time.

The combination wireless and wired token access distributed network and system shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed for providing a combination wireless and wired token access distributed network and system in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

1. A combination wireless and wired secure token access distributed network system comprising:
a) data token means for storing data, including unique customer identifier data;
b) one or more data collection and transmission node means that has a data memory for storing the location of said data collection and transmission means, for reading and inputting the data token data and extracting the customer identifier data, including location identifier data where said data token data collection and transmission means is in use, and transmitting said data;
c) one or more data access point means for receiving said transmitted data from said data collection and transmission means and extracting said unique customer identifier data and data collection and transmission means location identifier data; and
(d) network system controller means for receiving the data transmitted by said data access point means and informing a user of said network controller means of the customer identifier data and the data collection and transmission means location identifier data;
whereby when said network system controller is in use, it allows a user to centrally gather customer identifier data simultaneously with the location of the transmitting data collection and transmission node.

2. The combination wireless and wired secure token access distributed network system according to claim 1, wherein said data token means includes a magnetic stripe card.

3. The combination wireless and wired secure token access distributed network system according to claim 1, wherein said data token means includes a chip card.

4. The combination wireless and wired secure token access distributed network system according to claim 2, wherein said data collection and transmission node means includes a magnetic card reader having a wireless communications transmitter.

5. The combination wireless and wired secure token access distributed network system according to claim 3, wherein said data collection and transmission node means includes a chip card reader having a wireless communications transmitter.

6. The combination wireless and wired secure token access distributed network system according to claim 1, wherein said one or more data access point means includes a wireless communications capability whereby all said data collection and transmission node means within the broadcast radius of said data access point means is in wireless communications with said data access point means.

7. The combination wireless and wired secure token access distributed network system according to claim 1, wherein said data access point means includes a hard wired communications capability whereby said network system controller means communicates with said data access point means.

8. The combination wireless and wired secure token access distributed network system according to claim 1, wherein said network system controller means includes encoding means for encoding customer identifier data onto said data token means.

9. The combination wireless and wired secure token access distributed network system according to claim 1, wherein said data access point means stores the data from said data collection and transmission means in a format which is available for TCP/IP access.

10. The combination wireless and wired secure token access distributed network system according to claim 1, wherein said data access point means includes overlapping broadcast radiuses to enable multiple data access points to communicate with multiple data collection and transmission nodes and thereby enabling a built-in system redundancy.

11. The combination wireless and wired secure token access distributed network system according to claim 10, wherein said data access point means including overlapping broadcast radiuses to enable multiple data access points to communicate with multiple data collection and transmission nodes means includes one or more repeater access points in communication with said data access points to enable long range data communication between data collection and transmission nodes within and outside the broadcast radius of said data access points.

12. The combination wireless and wired secure token access distributed network system according to claim 1, wherein said network system controller means includes a central network system controller in wired communication with several peripheral network system controllers for the purpose of centrally gathering data transmissions from multiple data access points in communication with multiple data collection and transmission nodes.

13. An on-premises restaurant communication system for communicating an identifier for a customer's table to a central service counter, said system comprising:
(a) central service counter having a network system controller means for reading a data token that is provided to the customer when the customer places a food order, said token with a customer identifier number;
(b) data input means in a communication device mounted on the customer's table in the form of a data collection and transmission node for inputting the data token and extracting the customer number therefrom;
(c) data memory in the data collection and transmission node that stores the table identifier;
(d) a communication transmitter in the data collection and transmission node that transmits a message containing the extracted customer number and the table identifier;
(e) communication receiver means in a data access point device that receives the message and extracts the customer number and the table identifier therefrom; and
(f) a user interface in the network system controller that receives the extracted customer number and table identifier from the data access point and informs a food server of the table identifier for the customer's table.

14. The restaurant communication device according to claim 13 further comprising means within the network system controller for encoding a customer number on the data token.

15. The restaurant communication device according to claim 13 further comprising a communication transmitter in the data collection and transmission node that transmits a message containing the extracted customer number and the table identifier in short bursts in the 433 MHz radio frequency band to meet FFC transmission requirements at random intervals to avoid multiple collisions.

16. The restaurant communication device according to claim 13 further comprising a magnetic stripe reader for reading magnetic stripe data token in the data collection and transmission node.

17. The restaurant communication device according to claim 13 further comprising a chip card reader for reading chip card data token in the data collection and transmission node.

18. The restaurant communication device according to claim 13 further comprising:
(a) a communication transmitter and receiver in the communication device and data collection and transmission node that transmits a message containing the extracted customer number and the table identifier;
(b) said communication transmitter and receiver receives transmitted data integrity confirmation from the data access point; and
(c) a communication transmitter and receiver in said data access point that receives the message and extracts the customer number and the table identifier;
whereby said communication transmitter and receiver in said data access point transmits an acknowledgment back to the data collection and transmission node.

19. The restaurant communication device according to claim 18 further comprising a customer identification token reader data collection and transmission node with the capability to order menu items from the table and a payment token reader to accept payment for menu items ordered.

20. The restaurant communication device according to claim 19 further comprising:
(a) a customer identification token reader in the data collection and transmission node;
(b) a credit card magnetic stripe reader in the data collection and transmission node;
(c) an encryption engine to secure all sensitive payment token data prior to being transmitted by the data collection and transmission node;
(d) a data access point device capable of accepting the encrypted message from the data collection and transmission node; and
(e) accessing a payment gateway to process the payment transaction.

21. The restaurant communication device according to claim 13 further comprising a network system controller software application with a graphical interface to display table and data token status from the data access point including current table status such as length of time the customer has waited since ordering.

22. The restaurant communication device according to claim 13 further comprising multiple data access points each covering overlapping areas of the restaurant and said multiple data access point's each having wireless or wired connectivity to one or more network system controllers.

23. The restaurant communication device according to claim 13 further comprising portable computing devices which communicate with the data collection and transmission nodes and the data access points allowing servers to enter transactions for customer orders and payment processing.

24. The restaurant communication device according to claim 13 further comprising one or more data access points connecting to a network system controller through intranet and/or internet networks.

25. A wireless casino gaming controller and communication system for communicating game status and statistics, said system comprising:
(a) multiple data collection and transmission nodes which monitor and track the various game statistics;
(b) one or more network data access points and communications means for the game status to be transmitted to said network access points at regular time intervals;
(c) data collection and transmission node and communications means for said network access points to collect data from multiple data collection and transmission nodes and forward the collected information to a network system controller; and
(d) a software application in the network system controller to display the statistics of multiple games.

26. A wireless casino gaming controller and communication system according to claim 25 further comprising multiple network data access points each covering overlapping areas of the casino, and each of said multiple network data access points having wireless or wired connectivity to one or more network system controllers.

27. A wireless casino gaming controller and communication system according to claim 25 further comprising one or more network data access points which connect to a network system controller through intranet and/or internet networks.

28. A wireless casino gaming controller and communication system according to claim 25 further comprising a software application in the network system controller which directs a graphical user interface to display status and statistical data from all of the games being monitored at a remote location.

29. A wireless casino gaming controller and communication system according to claim 27 further comprising multiple data collection and transmission nodes that accept a data token containing player identification data for the purpose of player activity tracking, and a software application in the network system controller which monitors player tracking data and notifies management when defined criteria is met for player warnings and/or rewards.

30. A wireless casino gaming controller and communication system according to claim 27 comprising multiple data collection and transmission nodes which accept a secure token for player tracking and payment acceptance, and a software application within the network system controller through which monitors and records the secure token monetary value and validates the secure token for validity, and notifies the network system controller operator if a secure token has been compromised.

31. A wireless casino gaming controller and communication system according to claim 27 comprising portable computing devices which communicate with the data collection and transmission nodes and the network data access points allowing servers and game administrators to monitor game status and enter transactions for customer orders and payment processing.

32. A wireless casino gaming controller and communication system according to claim 27 further comprising multiple data collection and transmission nodes and network data access points where each network data access point gathers information from a group of data collection and transmission nodes called a micro-net, and further where:
(a) each micro-net operates on a different subset of the available RF frequencies to avoid data collisions;
(b) each network data access point scans its assigned set of frequencies for active data collection and transmission nodes and forwards the data to the network system controllers; and
(c) each data collection and transmission node selects the network data access point with the best signal integrity from a list of available micro-nets, whereby the list of micro-nets is supplied by the network system controller.

33. A wireless casino gaming controller and communication system according to claim 27 further comprising multiple network data access points in communication with multiple repeater access points where selected network data access points can forward information though said repeater access points to the network system controller.

34. A wireless casino gaming controller and communication system according to claim 33 further comprising multiple network data access points in communication with multiple repeater access points where selected network data access points can forward information though said repeater access points to the network system controller, said repeater access point are in wireless communication with each other as well as said network access points.

35. An entry access system communicating an identifier for an employee's identification and location to a network system controller and responding to the selected locations door activation with a access request, said system comprising:
(a) a data token and a data token input means in a communication device mounted on the access door in the form of a data collection and transmission node for the purpose of inputting the data token stored data and extracting the employee's identification therefrom;
(b) a data collection and transmission node and a communication transmitter in the data collection and transmission node that transmits a message containing the extracted employee identification number and the door identifier data;
(c) a data memory in the data collection and transmission node that stores the access door identifier data;
(d) a data access point and a communication receiver in said data access point that receives the message and extracts the employee id number and the door identifier therefrom; and
(e) a network system controller and a user interface in said network system controller that receives the extracted employee identification number and door identifier data from said data access point and validates the employee's entry authority, and sends a command to the door lock to enable entry.

36. The entry access system according to claim 35 further comprising means within the network system controller for encoding an employee identification number on the data token.

37. The entry access system according to claim 35 further comprising a communication transmitter in the data collection and transmission node that transmits a message containing the employee identification number and the door identifier data in short bursts, in the 433 MHz radio frequency band to meet FFC transmission requirements, at random intervals to avoid multiple collisions.

38. The entry access system according to claim 35 further comprising a magnetic stripe data token and a magnetic stripe reader for reading said magnetic stripe data token in the data collection and transmission node.

39. The entry access system according to claim 35 further comprising a chip card data token and a chip card reader for reading said chip card data token in the data collection and transmission node.

40. The entry access system according to claim 35 further comprising a communication transmitter and receiver in said data collection and transmission node that transmits a message containing the employee identification number and the door identifier data, and receives the transmitted data integrity confirmation from the data access point; and a communication transmitter and receiver in the data access point that receives the message and extracts the employee id number and the door identifier and transmits an acknowledgment back to the data collection and transmission node.

41. The entry access system according to claim 35 further comprising a network system controller having a software application with a graphical interface to display all access points status from the data access point including current door status.

42. The entry access system according to claim 35 further comprising multiple data access points each covering overlapping areas of an organization, and each with wireless or wired connectivity to one or more network system controllers.

43. The entry access system according to claim 35 further comprising portable computing devices which communicate with the data collection and transmission nodes and the data access points, allowing emergency and security personnel to enter any door quickly at any time.

44. The entry access system according to claim 35 further comprising one or more data access points connecting to a network system controller through intranet and/or internet networks.
